(19) United States
(12) Patent Application Publication
(10) Pub. No.: US 2002/0161752 A1
(43) Pub. Date: Oct. 31, 2002

(54) Apparatus for and method of searching

(76) Inventor: William J. Hutchison, Bath (GB)

Correspondence Address: NIXON & VANDERHYE P.C., 8th Floor, 1100 North Glebe Road, Arlington, VA, 22201, US

(21) Appl. No.: 10/104,070

(22) Filed: Mar. 25, 2002

Related U.S. Application Data
(63) Continuation of application No. PCT/GB00/03652, filed on Sep. 22, 2000.

(30) Foreign Application Priority Data
Sep. 24, 1999 (GB) 9922726.6
Jul. 20, 2000 (GB) 0017895.4

(51) Int. Cl. G06F 7/00

(52) U.S. Cl. 707/3

(57) ABSTRACT

In an apparatus for use in searching, a user enters a keyword and the apparatus returns a first wordset (2) having a first lexical relationship with the keyword and a second wordset (3) having a second lexical relationship with the keyword. The terms in the wordsets (2,3) can be used in the creation of a search string for carrying out a search.

The present invention relates to apparatus and a method of searching. In particular, but not exclusively, the invention relates to an apparatus and a method of forming a search string for use in searching. The invention finds general application in all kinds of searching including searching for information from a wide range of sources, for example databases and computer based networks, for example the Internet. In a preferred embodiment, the invention is used in searching the World Wide Web.

Searches may be carried out, for example, in a database, or on the Internet to find information relating to, for example, a particular subject. Often the information to be searched is held electronically, for example in a computer, and the search is carried out using a search engine on a computer The search may use one or more search terms. Such search terms may be a word or group of words; the search looks for information including the word or words.

The difficulties involved in carrying out such searches are well known. Particular difficulties arise in knowing what search terms to use. In the past, complex searches have been carried out by experienced searchers. However, in particular with the increase of information available to ordinary members of the public, in particular the expanding popularity of the Internet, users having little or no search experience or specialised training are carrying out searches for information.

Most search engines rely on the user to input a string of relevant keywords to describe the information they wish to retrieve, for example from the Internet We have found that ordinary users find such search engines difficult to use effectively. Unfamiliarity with subject terminology and context can lead users to frame ineffective queries, which in turn can generate huge volumes of irrelevant search results.

For example, if a user enters a simple word such as “car” into a known search engine, the user will be inundated with thousands of responses, most of which are not relevant to the topic of cars itself. Entering additional terms such as “convertible” and “red” can narrow down the displayed results to a more manageable list. However, a search for information relating to “red” “convertible” and “car” might not find the information of interest to the user, if the information only refers to a “scarlet convertible automobile”.

Thus difficulties arise even in searching relating to a simple subject; where the user is less familiar with the subject matter of the search, the selection of suitable search terms is even more difficult.

There is a demand for tools to assist in the searching for information.

There are known search engines, commonly called “directories”, in which areas of interest are arranged according to subject matter in a hierarchical structure. The user is presented with the entirety of the structure's top level. He selects one subject, and a greater level of detail in that subject is revealed on a fresh page one level down. This “drilling down” can take the user through four to six levels, until he receives a list of relevant web resources. (In some such directories, information is classified using the Dewey Decimal System.) The navigation of this kind of hierarchical structure can be time consuming and confusing.

A further problem is that much of the information available on the Internet is in English and searching for information, and using known search engines, can be difficult for non-English speaking users.

It is an object of the invention to provide an improved search engine which overcomes or mitigates one or more of the problems identified above.

According to the invention there is provided an apparatus for use in searching, the apparatus including:

means for selecting a keyword;

means for determining a first wordset, the first wordset having a first lexical relationship with the keyword; and

means for determining a second wordset, the second wordset having a second lexical relationship with the keyword.

We have found that language-related problems are foremost among the difficulties of users. By determining words which are lexically related to the keyword selected by the user, the user can select terms to modify the search terms thereby improving the search carried out.

The keyword may be selected from a data store in the apparatus in response to an input from a user.

The method for selecting a keyword may comprise the use of an input device, for example a keyboard at a computer, and/or may comprise use of a control device adapted to receive instructions for selecting a keyboard from a remote device, for example a remote computer, via a communication link.

The invention further provides an apparatus for use in searching in respect of a keyword, the apparatus including:

means for determining a first wordset, the first wordset having a first relationship with the keyword; and

means for determining a second wordset, the second wordset having a second relationship with the keyword.

Preferably, the first wordset includes a hyponym of the keyword. Thus the first wordset includes terms having a meaning included in the meaning of the keyword. These are referred to below as “children” of the keyword. For example, if the keyword is “star”, the first wordset may include the terms “binary star” and “giant star”.

“Term” is used herein to refer to entries in a wordset. The term may be a single word or may be more than one word, for example “binary star”. The terms of a particular wordset are connected conceptually and lexically to other terms in the wordset. In most cases, the terms of the wordset are children of terms of a parent wordset.

The number of terns included in each wordset will depend on the complexity of the search to be carried out, but may be at least 2 and is preferably not more than 12. The first wordset may include at least five hyponyms of the keyword.

Thus by determining hyponyms of the keyword, more specific terms related to the keyword are determined. By including the hyponyms in the search terms, the search can be narrowed and the number of irrelevant results in the search reduced.

Preferably the second wordset includes a hyperonym of the keyword. Thus the second wordset includes terms of which the keyword is a hyponym. The terms of the second wordset are referred to below as “parents” of the keyword. Thus, if the keyword entered by the user is too specific, the search term can be modified to include the hyperonym of the keyword, thus increasing the possibility that relevant information will be found in the search.

In a preferred embodiment, the second wordset includes one term, but may include more than one term.

Preferably, the apparatus further includes means for determining a third wordset having a third lexical relationship with the keyword. Thus further possible search terms related to the keyword can be identified.

Preferably the third wordset includes a hyponym of the second wordset, and preferably includes at least five hyponyms of the second wordset. Thus the third wordset may include terms which are in the same wordset as the keyword, and may include synonyms of the keyword. The terms of the third wordset are referred to below as “close relations” of the keyword.

Preferably, the apparatus further includes a fourth wordset having a fourth lexical relationship with the keyword, and preferably the fourth wordset includes a further hyperonym of the keyword. Thus, where the keyword can have more than one meaning, the keyword may have more than one “parent”. One wordset of parents is the second wordset; other parents form the fourth wordset. The terms of the fourth wordset are referred to below as “distant relations”.

Preferably, the apparatus further includes means for determining a fifth wordset, the fifth wordset including a hyperonym of the second wordset. The terms of the fifth wordset are referred to below as “grandparents” of the keyword.

Preferably, the apparatus further includes means for determining a hyperonym of the fifth wordset.

That hyperonym is referred to below as the “great-grandparent” of the keyword.

Preferably, the apparatus further includes a display, wherein the display is adapted to display terms of the wordsets and preferably also the keyword. Thus, when a keyword is entered into the apparatus, a network of terms related to the keyword can be displayed. The user can therefore see further terms, having a lexical relationship to the term which be has selected, and which may be appropriate for use as search terms in the search to be carried out.

Where the user is carrying out the search from a remote terminal, for example, it will be understood that the terms will preferably be displayed on the user's terminal and the central search apparatus will include means for outputting the terms of the wordsets, and preferably the keyword, for display at the user's terminal.

It will be understood that the apparatus can be arranged to display any desired combination of the wordsets. Also, only particular wordsets may be determined for a particular application. For example, in some cases only the close relations of the keyword will be determined. Alternatively, only the distant relations may be determined. Any combination of the wordsets may be determined as desired.

The user may see a structure of up to 100 terms at any one time, all of which are closely related to the single keyword inputted.

Preferably, the apparatus includes means for replacing the keyword with a displayed term. Preferably, new sets of terms having a lexical relationship with the new keyword will then be displayed. Thus the user can navigate through the wordsets looking for terms for use in the search.

Preferably the apparatus includes a cache for storing terms and selection means for selecting terms from the wordsets and entering the terms in the cache, and preferably storing the terms in the cache in the form of a search string. When the user locates terms in the wordsets displayed. he can select them for use in the search. Where more than one term is to be used, preferably the apparatus includes means for including suitable Boolean operators to connect the search terms.

Preferably, the apparatus includes search means for carrying out a search of the database using the terms in the cache. The apparatus preferably includes means for formatting the string and, when required, to send the formatted string to the search engine to carry out the search.

In an alternative embodiment, the terms of the wordsets might not be displayed. For example, the search engine can be arranged automatically to include in the cache in addition to the keyword, additional terms from wordsets having particular relationships to the keyword. For example, the apparatus could be adapted to include in the search term the keyword and all of the close relations of the keyword. Those search terms will usually be connected by a Boolean AND operator, but the terms might be connected in the search string by other Boolean operators to broaden the scope of the search carried out.

Preferably, the apparatus further includes a plurality of wordsets, each wordset including a plurality of terms and each wordset having a lexical relationship with at least one other wordset.

Preferably, the apparatus includes lexical information associated with each term, the information preferably including at least one of a wordset to which the term belongs and a hyperonym of the term.

Preferably, the apparatus includes lexical information associated with each wordset, the information preferably including at least one of a hyperonym wordset and a hyponym wordset of the wordset.

The apparatus finds particular use with a search engine for searching for information on a computer based network, for example the Internet.

The invention further provides an apparatus for forming a search string for use in a search, the apparatus comprising:

means for entering a keyword;

means for determining a plurality of terms, the terms having a lexical relationship with the keyword; and

means for forming a search string including one or more of the terms.

The invention further provides an apparatus for use in searching in respect of a keyword, the apparatus comprising:

a data store including a plurality of terms and lexical information relating to the terms

a control device adapted to receive the keyword, and to determine a first wordset of terms having a first lexical relationship with the keyword, and a second wordset of terms, having a second lexical relationship with the keyword.

The apparatus may further comprise means for formatting the search string for use by a search engine in a search.

The invention also provides a method of forming a search string, the forming of the search string comprising the steps of:

entering a keyword;

determining a wordsets, the wordset including terms having a lexical relationship with the keyword; and

selecting a term from the wordset to form a search string including the selected term.

Preferably, the method further includes the step of displaying the wordset.

Preferably, the method further includes the step of replacing the keyword with a term of the wordset.

Preferably the method includes determining two or more wordsets, each wordset including terms having a different lexical relationship with the keyword.

Also provided by the invention is a method of searching, the method including forming a search string as described above and carrying out the search using the search string.

The invention further provides a method of searching using an apparatus as described above.

According to a further aspect of the invention there is provided a method of carrying out a search including: generating a plurality of terms for selection, for example by a user; determining that a term has been selected; and initiating a search on the basis of the term selected.

The invention also provides a method of generating a search string in respect of a keyword, the method comprising:

determining a wordset including a term having a lexical relationship with the keyword; and

using the wordset to form a search string.

Information resources in general and the World Wide Web in particular have become very large, it has become very difficult to search through them effectively for specific pieces of information.

Searchable indexes store keywords taken from documents. Users of search indexes enter a term(s) which indicates what interests them, and the index returns a set of documents in which that term occurs. It is thus hoped that the user's interest and the content of the document will match.

Unfortunately, these techniques do not always yield appropriate results, for the following reasons, among others:

The user will often employ a term that is different to the term the author of the document he is seeking has used. For example, the user asks for documents about ‘babies’ when the author has entitled his document ‘infants’ and used that term throughout.

The user employs a term that is not generally accepted in a community of authors. For example, the user asks for documents about ‘heart attack’ when the term medical authors have used is ‘myocardial infarction’.

The user employs a term that is ambiguous, for example, ‘bank’. He wished to locate documents related to financial institutions, but the index also returns documents related to aircraft manoeuvres and the sides of rivers.

The user misspells the term.

The user is unable to generate a term because he is not sufficiently familiar with the subject.

The user is not searching in his native language, and finds as a result that all the above problems are exacerbated.

An additional problem arises that the use of a single term or of a general term generates an excessive quantity of results that the user is unable to examine.

Several methods have been proposed to try to overcome these problems.

Directory

The user is provided with a hierarchical directory of subject categories through which he can navigate without having to formulate query terms Most of the categories hold a set of results provided by category editors. Yahoo or About.com are examples of this approach.

A problem with this approach is that the directory results are limited in scope by the fact that they must be hand compiled. They are also subjective and potentially biased.

Computational

Results sets are ranked so that the ‘best’ results appear at the top of the user's page. Relevance rankings of this kind have traditionally relied on linguistic/statistical techniques that attempt to draw conclusions about the content of documents and the importance of keywords within them. A further invention in this area is the analysis of the number of hypertext links that point to a given page.

A problem with this approach is that while computational techniques are partially successfil, they cannot provide users with context and subject knowledge.

Query Expansion

Query expansion is a technique for improving information retrieval results. In an implementation of query expansion, the search index program presents the user with a dialogue box asking him if he would like to add terms to the search string. He generates terms, then initiates the search.

A problem is that the user is obliged to generate his own query terms and he may find this difficult if he is unfamiliar with the subject area.

Other suggested models include:

Automated query expansion in which a program adds a set of terms drawn from a knowledge base to the user's search term. However, the program may add inappropriate terms.

Search disambiguation in which the user enters a term and the program opens a dialogue asking the user to choose between meanings. While this can be useful, it relies on the user to generate the initial search term.

By providing terms for selection by the user and carrying out a search on the basis of the terms selected by the user, more accurate and focused query expansion can be achieved. The user is presented with options for refining the search so the risk of inappropriate or unhelpful terms being entered by the user is reduced. However, by requesting input from the user, the risk of including inappropriate automatically generated search terms in the search string can be reduced.

In preferred embodiments, the method is computer based, and may be Internet based. In that case, the computer (for example a server) preferably runs a program which is accessed by the user via a remote connection. The generated terms are displayed on the user's computer and he selects terms from the display, for example using a mouse.

The plurality of terms preferably comprises a set of terms related to a selected term which may, for example, have been generated or selected in a previous search step or entered by a user.

Preferably the search is initiated by forwarding search terms, for example a search string, to a search index. The invention finds particular application in the searching of a computer network, for example the Internet.

The present invention aims to improve the search by presenting the user with a context for each term he enters. The terms presented to the user for him to choose are preferably within a single context and so preferably have one sense or meaning. By adding terms to the search query that are contextually related, the problem of ambiguous terms can be reduced.

Preferably the method further comprises displaying the search results.

Preferably the method is such that the selection of the term initiates the search. Preferably as the user navigates through the terms, the search is carried out at each stage that a term is selected so that the user obtains feedback of the success of his search as he proceeds.

Preferably, the term is selected using a single user action. This action may, for example comprise a mouse-click on the relevant term on a computer display. It will be understood that any method of selecting the term could be used. In preferred embodiments of the invention, a single user action selects the term and initiates the search. The user action may be one click for example of a mouse button.

Also provided by the invention is the expansion of a search query by selecting one of a plurality of links, preferably hypertext links, in an interface.

Preferably the method further includes the step of carrying out the search using a predetermined search string associated with the selected term. In preferred embodiments of the invention, each of the terms has associated with it a preformatted search query string and the search string is used to expand the user's search query. The prefonnatted string is forwarded to one or more search indexes when the user selects the relevant term. Preferably the user is able to amend the search string.

Preferably the method further includes the step of generating a search string on the basis of the term selected.

This feature is of particular importance and is provided separately. Thus the invention further provides a method of generating a search string including: generating a plurality of terms; determining that a term has been selected; and generating a search string on the basis of the term selected. In preferred embodiments, a map of terms is presented to the user who chooses one or more of most relevance to his query. As he selects the terms, elements are added to a search string to build up a search string for the search which becomes more and more relevant to his enquiry as he navigates through the map of terms.

Where reference is made to generating a group, set or plurality of terms, preferably the method comprises displaying the group, set or plurality of terms.

The invention also provides a method of searching including generating a search string as described herein and using the search string in a search.

Thus embodiments of the invention allow the user to expand a search query based on a map of terms that are clustered together with respect to term meaning. The presentation of terms within a contextual map according to preferred embodiments of the invention provides the user with a powerful tool for expanding a query. A term is preferably added to the query string by clicking once on any term in the contextual map of terms. The advantage of using this method to build a query string is that the individual terms in the query string, that may otherwise be ambiguous, take on a specific meaning within the context of the query string as a whole thus allowing word sense disambiguation in query expansion.

In embodiments of the invention, only the selected term is added to the search string when the term is selected. Thus the invention may provide a glossary of terms for the user to employ in building up a search string. In preferred embodiments, however, other terms in addition to the selected term are added to the search string when the term is selected. Thus for each selected term, for example, plurals, synonyms and other words can be added to the search string. Thus in preferred embodiments of the invention, the method includes the step of adding further terms to the search string on the basis of the term selected.

As indicated above, the further terms to be added may comprise a predetermined search string or search string fragment associated with the term, for example in the database.

Preferably the method further includes generating a further plurality of terms on the basis of the term selected. Thus on selection of the term, the displayed terms are preferably changed. Thus the displayed terms are revised to show terms more relevant to the selected tern.

Preferably, the method includes generating a plurality of groups of terms, one group having a relationship to another group. The terms may be arranged in a hierarchical relationship, and preferably terms having a particular relationship with the focus term are grouped together in the display. The navigation of the database of terms by the user can therefore be made easier. For example, if the user wishes to narrow his search, he may choose a term from the group of “children” of the focus term.

Thus the method preferably includes generating terms related to the selected term, and preferably generating groups of terms related to the selected term. Preferably each term or group of terms has a different relationship with the focus term. That relationship may be a lexical or other relationship.

Preferably the method further includes the step of determining that a further term has been selected and initiating a search on the basis of the further term selected and/or the step of determining that a further term has been selected and generating a search string on the basis of the further term selected.

Preferably the method includes the step of storing information relating to the selected term and preferably the method includes using the stored information in the generation of the search string. Thus information relating to the interests of the user can be collected and used to improve future searches by selecting terms to display on the basis of the user's perceived interests as determined by his previous searches. For example, if the user often looks at Internet sites related to music, that information will be stored and if, in a subsequent search he enters the term “Madonna” a guess can be made that he is searching for information about the singer rather than for religious information.

The method may further comprise the step of automatically including terms in the search string. These additional terms are preferably stored in the database for each term for use as a search string or part of a search string.

This feature is of particular importance and is provided separately. Thus the invention further provides a method of generating a search string, the method comprising adding terms to a search string on the basis of a selected search term.

Preferably those terms are predetermined for each term of the database. The terms may be determined from monitoring the user's previous searches (user specific) or may be based on general user data, for example statistics of the most searched subject matter, they may be lexically related terms, linked terms for example terms often found together (for example Bath and Spa). Part of the expansion of the query may be automatic.

In embodiments of the invention the method comprises tracking a user's path through an interface, and generating a search string on the basis of the path. Thus with each step through the network of terms, more terms are added to the search string. Provision may be made so that if the user “doubles back”, terms will be deleted from the search string on the assumption that it was a “wrong turn”.

This feature is of particular importance and is provided separately. Thus the invention further provides a method of generating a search string including tracking a user's path through an interface and generating a search string on the basis of the path.

The invention further provides a method of carrying out a search including: generating a first set of terms; determining that a first term has been selected of the first set of terms; initiating a first search on the basis of the first term; generating a second set of terms on the basis of the first term; determining that a second term has been selected of the second set of terms; and initiating a second search on the basis of the first term and the second term.

Further provided by the invention is a method of searching, the method comprising: viewing a set of terms; and selecting a term from the set of terms; wherein the selection of the term initiates the search andlor the selection of the term generates a search string. Preferably the user is able to continue navigating through the terms and thus preferably the method further comprises viewing a further set of terms and selecting a further term from the further set of terms, wherein the selection of the further term initiates a further search. Preferably the further search is carried out on the basis of the term and the further term. Thus as the user navigates through the terms, the search becomes more refined.

Also provided is a computer based method as described above and an apparatus for carrying out any of the methods described herein.

The invention provides an apparatus for use in searching the apparatus including: means for generating a plurality of terms; means for selecting a term; and means for initiating a search on the basis of the term selected. Preferably the apparatus further comprises means for generating and preferably displaying the search results.

Preferably the means for selecting the term, means for initiating the search and means for displaying the results, and other parts of the apparatus defined herein for carrying out specific steps comprise, where appropriate, a suitably programmed processor.

An apparatus for use in searching is also provided, the apparatus comprising a data store including a plurality of terms, a control device for genetating a set of terms chosen from the terms in the data store. for determining that a term has been selected from the set of terms, and initiating a search on the basis of the term selected.

Preferably, the apparatus described herein includes means for displaying the generated terms, preferably the apparatus includes a display, for example a VDU.

Preferably the apparatus is such that the selection of the term initiates the search.

Preferably the apparatus further includes means for retrieving a predetermined search string associated with the selected term.

Preferably the invention provides means for generating a search string on the basis of the term selected.

Also provided by the invention is an apparatus for use in searching, the apparatus including: means for generating a plurality of terms; means for selecting a term; and means for generating a search string on the basis of the term selected.

Preferably the apparatus further includes a memory for storing information relating to the selected term.

Preferably the apparatus includes means for adding terms to a search string on the basis of a search term.

Also provided by the invention is an apparatus for generating a search string, the apparatus comprising means for: tracking a user's path through an interface; and generating a search string on the basis of the path.

Preferably the apparatus is adapted for use in searching a computer based network and preferably the apparatus comprises a computer system. In preferred embodiments of the invention, the apparatus comprises a server in a computer network.

The invention provides a method of searching using an apparatus described herein.

The invention further provides a database of terms for use in a method or apparatus described herein.

The invention provides a database comprising a plurality of terms, and further comprising a search string, wherein the search string is associated with a term. Preferably the database comprises a plurality of search strings, each search string being associated with a term of the database. Preferably the terms comprise a hierarchical structure. The invention also provides the use of a database described herein in searching.

The invention provides a computer adapted to carry out a method described herein and a computer program for carrying out a method described herein.

The invention further provides a computer-readable storage medium having a program recorded thereon which is adapted to operate according to a method described herein. The a computer-readable storage medium may further include a database as described herein.

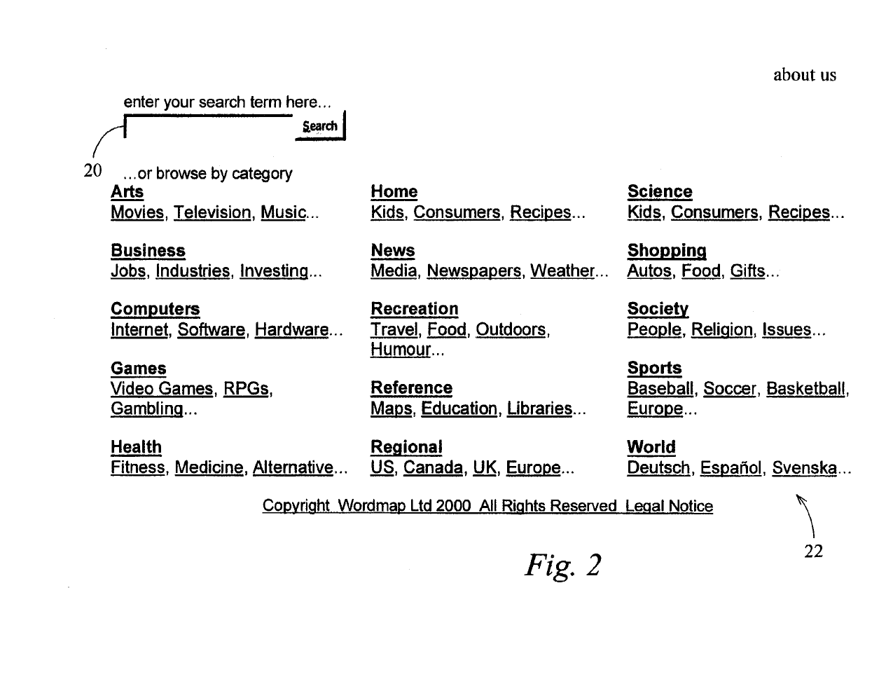

The invention further provides an apparatus for use in searching and/or a method of searching, being substantially as herein described having reference to FIGS. 2 to 4.

Thus embodiments of the invention provide a Web-based application for assisting users with the arduous task of searching the Web. It displays hierarchically related words for a given query term in the form of a navigable map. An aim of the invention is to help users with Web searching by suggesting or prompting them with terms to expand the search query in order to satisfy their search needs more closely. Through a navigable display of related terms, the user can focus on the appropriate terms that he is interested in a number of ways: by enriching the search query with more specific terms, by enriching the search query with like terms, enriching the query with more or less general terms or by enriching the search query with terms related to another sense of the original term.

This strategy helps the user build a rich search query and has the advantage of building a context for the particular sense of the query the user wants. This rich search query when sent to a search engine can retrieve fewer irrelevant results that a search query not using the query expansion facility. We believe that larger search queries do better at retrieving relevant results than queries with fewer terms. Since most users input on average two terms per search query, by using a query expansion technique, the results of their searches could be improved.

Where the term “hierarchy” is used herein, it should preferably not to be taken to imply a specific structure of interrelationship between the nodes of the hierarchy. For example the hierarchies described herein may include one or more uppermost nodes.

Preferably each term may include one or more words, symbols or other elements.

Apparatus features may be applied to the method features and vice versa. Features of one aspect of the invention may be applied to other aspects.

Where features of the apparatus are described herein as “means for” a particular function, it is intended that those terms be interpreted broadly and are preferably not interpreted to be limited to any particular embodiment of the invention described herein. Features of the apparatus are, in preferred embodiments, provided by a suitably programmed computer or computers, and thus feature of the apparatus are provided by the relevant features of a computer system or product comprising a computer program. For example, features of the apparatus may be provided by a suitably programmed computer processor, or other part of a computer system, for example a memory device or data store.

Embodiments of the present invention will now be described, purely by way of example, with reference to the accompanying drawings. in which:

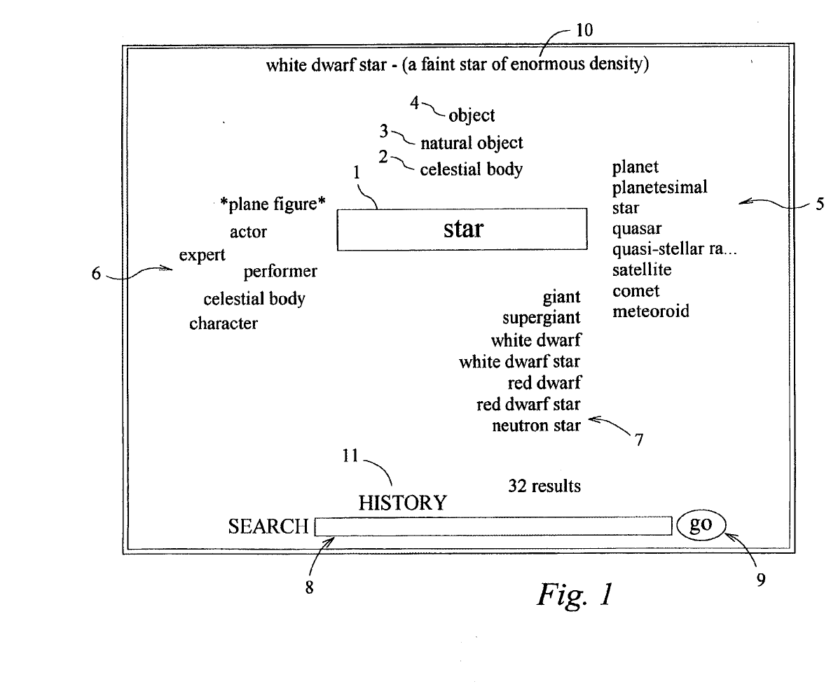

FIG. 1 shows an example of a display of terms of wordsets;

FIG. 2 shows a display of an opening page of a second example;

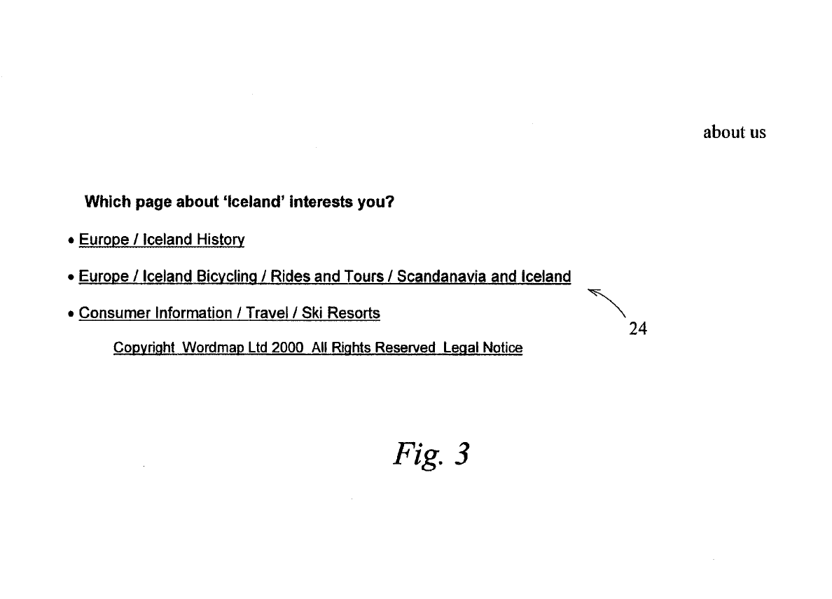

FIG. 3 shows a display for a search term requesting the selection of an instance of the term; and

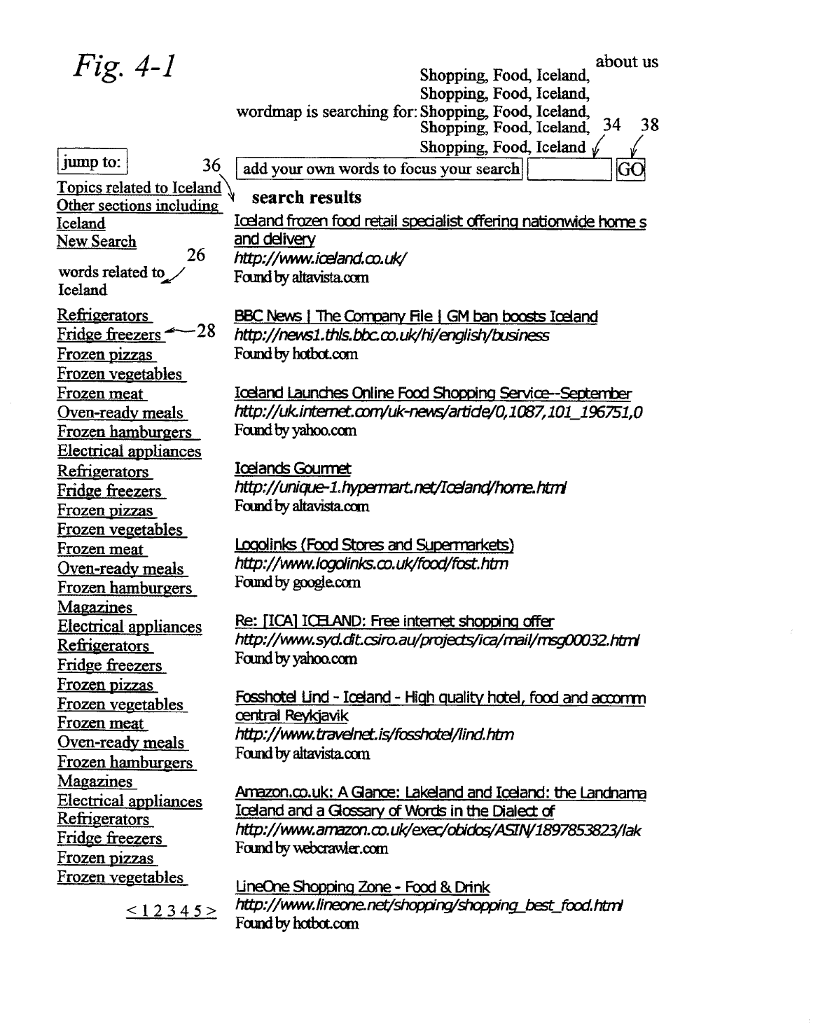

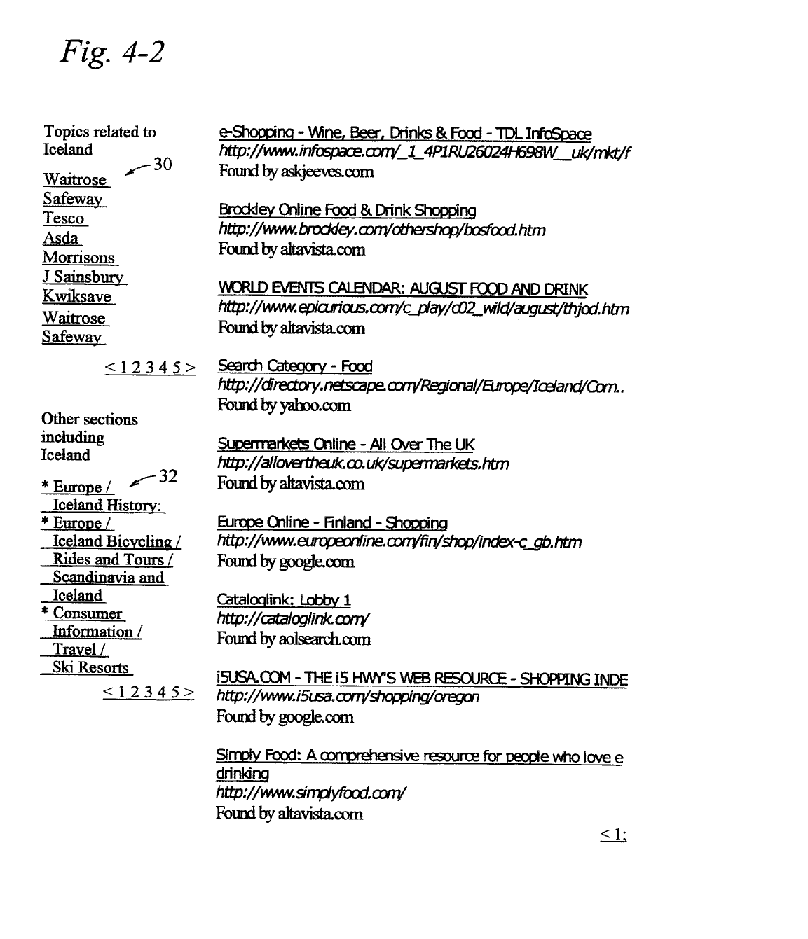

FIG. 4 shows a display for an instance for the search term.

The apparatus is a visual search interface linked to an underlying lexical database. It displays several sets of lexical relations drawn from the lexical database. These relations are governed by principles based on an adapted family tree and are the same regardless of the subject being searched.

The lexical searcher apparatus includes three main components:

1. A visual interface displayed in a Web browser which displays terms, allows terms to be moved and makes calls to a middle layer;

2. A lexical database, which provides the words that are placed in various parts of the interface. The lexical database stores links of family relation between terms. This family relation is based on the parent-child principle. Links to parents and children are stored as part of the entry for each individual term. The presence of these links allows the database to return information in the ways outlined below, and to respond to queries asking:

1. what a given term's children are

2. what a given term's parents are

3. what the other children of the given term's parents are

4. what other parents a given term has.

For the example below, all terms are organised according to this parent-child principle; and

3. A middle layer which formats and processes interface commands and returns of data from the lexical database

In the present example, the search is to be carried out on the Internet and the lexical searcher is connected to a search engine, which carries out the search once the search string has been formed by the user using the lexical searcher. Components 1 and 3 of the lexical searcher will typically run on a client PC and component 2 on a remote or local server, although component 2 may also run on a client PC.

To begin the search, the user inputs a term (Keyword) by typing into an input box managed by the interface system. The interface system then calls four lexical database functions using the input string as an argument to each function. The lexical functions access the lexical database, returning the information that is requested for the given input string. The lexical database is a hierarchically structured dataset where the data elements are related to each other using a “kind of” relation. For example, a “nova” is a kind of “star”, which is a kind of “celestial body”.

Thus the hierarchy in the lexical database is:

“object” . . . “celestial body”. . . “star” . . . “nova”.

Terms “above” the keyword in the hierarchy are “parents” and those “below” the keyword in the hierarchy are “children” of the keyword. Thus “celestial body” is a parent of “star” and “nova” is a child of “star”.

The lexical relations being used by the lexical database access functions are hyponomy (children of the keyword) and hyperonomy (parents of the keyword).

The functions retrieve the following data:

1. The parents of the keyword

extern char **WM_ancestors (char *word, int sense, int depth);

returns an array of strings containing the parents of the keyword up to specified depth. Where there is more than one sense of the keyword, the parents of one sense of the keyword are returned. This is the parents wordset. The terms of the parents wordset are displayed above the keyword in the interface window.

2. the children of the keyword

3. the close relations of the keyword (the children of the parent of the keyword)

extern char **WM_close relations (char *word, int sense);

returns an array of strings containing the children of the keyword specified by sense. This function serves two purposes; it returns the children wordset of the keyword (these terns are displayed below the keyword in the interface window) as well as the other children of the parent of the keyword (those terms are displayed on the right side of the keyword).

Children can be related to the keyword in various ways: they may be for example “types of”, “parts of” or synonyms.

4. distant relations of the keyword (those parents of the other senses of the keyword)

extern char **WM_distant_relations (char *word, int sense);

returns an array of strings of the parents of all the senses of the keyword except the one specified as sense (as the parent in (1) above). These terms of the distant relations wordset are displayed to the left of the keyword.

Thus each of the functions returns a list (wordset) of terms (words/phrases), which the interface then displays in different areas of the lexical searcher window. FIG. 1 shows the window displayed when the keyword STAR is entered into the input box 1. Parents 2 (in this case CELESTIAL BODY), grandparents 3 (NATURAL OBJECT) and great-grandparents 4 (OBJECT) of the keyword are displayed above the keyword. Close relations 5 (PLANET, PLANETESIMAL, STAR, QUASAR etc) are displayed to the right of the keyword and distant relations 6 (PLANE FIGURE. ACTOR, EXPERT etc) are displayed to the left of the keyword, with children 7 (GIANT, SUPERGIANT, WHITE DWARF etc) being displayed below the keyword.

The user can drag terms he believes to be relevant to his query to the search box 8 in the interface. Those input terms are used to build a search string which will be passed to the search engine for accessing documents on the Web or other database. A user can also type directly into the search box.

On the user's command (GO button 9) the interface passes the search string (possible more than one input term) to the search engine for retrieval of relevant document from the Web or other database. The user then receives the results of the search. The results contain a list of relevant documents with hyperlinks to those documents.

The user can continue to build a search string by adding any of the terms that appear in the window. This is an iterative process and can go on as long as the user likes.

The lexical search apparatus can also have a number of other functions, including:

a. A definition of any term is displayed 10

extern char *WM_gloss (char *word, int sense);

returns the definition (if any available) for a term. This is displayed at the top of the window. The text under scrutiny by the user may be highlighted and the full description may scroll across the top of the window, if appropriate.

Text already examined may be marked, for example using bullet points, so that the user does not accidentally examine it again.

b. Option for selecting the underlying search engine to be used. Thus, once a search string has been built, the same (or different) search can be carried out using several search engines.

c. A BACK button (not shown) allows the user to return to a previous term set

d. A HISTORY pop-up menu allows the user to view the last, for example five, search strings and return to whichever he wishes.

Users can browse the lexicon by taking the terms that interest them and moving them to a central keyword box 1. The relations shown in the rest of the interface are governed by the term in the central keyword box 1.

For many applications, a general database of lexical terms will be used but, for some applications dedicated lexical databases would be used. For example, specialised databases for scientific, medical or other fields and containing terms specific to the relevant field would be used. Thus, the lexical searcher may include a facility for choosing the lexical database to be used for the search to be carried out.

Furthermore, the lexical database may be supplied separately from the lexical searcher. The lexical database and/or lexical searcher may be supplied on a suitable data carrier.

Further lexical, or other, relations may also be provided.

A second example is now described having reference to FIGS. 2 to 4. The second example uses a database and searcher similar to that of the example above and description of the operation of that example applies also to the example below. In the second example, the data elements (terms) are related to each other by lexical or other relationships.

The following example describes a program and method which enables users to generate expanded queries for Web search. The query can be expanded using a single click. In this example. the context provided by directories can be combined with the scope and scale of the Web.

In the following example, users navigate an interface in which terms, concepts and subjects are presented in a structured classification similar to a Web directory. In this example this structure includes:

A subject category, (or ‘focus term’), which is the object of the search

Sub categories.

Other subject categories related to the focus term by virtue of a shared parent.

Other subject categories related to the first by virtue of the common use of a keyword.

| Type of Information | Example (see Figures 2 to 4) |
|---|---|
| Subject (‘focus term’) | Iceland |
| Sub categories | Refrigerators, fridge freezers |
| Shared parent | Waitrose, Tesco |
| Keyword | Europe |

When a user clicks on any of the above objects in the Interface, two actions are initiated:

The focus term is replaced.

A search of one or more Indexes of content is initiated, using an expanded search string stored in a database entry associated with the focus term.

The user is thus enabled to initiate an expanded query by clicking on any of a number of hypertext links in an interface.

The expanded query string can include:

The focus term's immediate parent category.

Relevant synonyms known to be associated with the focus term and held in its database entry.

other terms determined by editorial decision to be frequently associated with it.

Terms known not to be wanted in a specific instance, and therefore to be excluded by the use of a Boolean NOT operator or other similar technique.

An example of a search by a user is as follows:

The user arrives at the opening page (FIG. 2). The page includes a search box 20 which is a dialogue box for entry of a search query. The page also includes a list of category items which comprise links 22.

He chooses either to enter a term in the search box 20 or to click on one of the category links 22 shown.

If he enters a term in the search box 20, in this example the term Iceland, the program makes a call to the database to determine whether there is more than one instance of that term. If there is more than one instance, the user is asked in a new screen to choose between instances.

FIG. 3 shows a screen in which the user chooses an instance of Iceland from the links 24 shown.

When he clicks on one option, a new screen is provided as described above.

A call to the database is made to provide the information detailed above, including:

Subcategories belonging to the focus term

Other subcategories of the focus term's parent

Other instances of the focus keyword in the database

The search string associated with the focus term

These are displayed in the new screen (see FIG. 4).

In the screen of FIG. 4, the search term ‘Iceland’ is displayed 26. Below are listed the “children” of Iceland 28. Also listed are “topics related to” Iceland 30 which include terms having the same parents as Iceland (siblings). Listed below are the “distant relatives” 32 (uncles) of Iceland which include the different instances categories 24 of FIG. 2. A request is also made to the web server which returns search results 36.

The search query can be expanded in various ways.

The interface provides a box 34 inviting the user to add terms to the query string.

The user may simply add one or more terms of his choice to the existing search string by typing them in the box 34 and selecting ‘GO’ 38.

Alternatively, or in addition the query can be expanded by the user by clicking on one of the related terms 28, 30, 32.

For example, if the user is interested in electrical appliances (which is in the ‘children’ terms 28), he clicks on that term. This initiates a further web search. The search string stored in the database for that term is returned and used in the search. The returned search string for the search may be combined with the search string used for the previous search, or in some cases may be used alone. Other combinations of new and previous search terms could be used.

The search is carried out and the results are returned. Note that the query expansion and initiation of the search are implemented using a single click by the user on the related term.

The search results are displayed on a new screen. The related term are also redrawn having ‘electrical appliances’ as the focus term. The related terms are shown in respect of the new term.

To carry out the search, the program sends a request to the Web server, which formats a search request to the target search indexes using the supplied query string together with any terms the user may have added.

The search indexes return results to the Web server, which formats them and returns them to the search interface.

In an example where the user does not enter a search term on the opening page (FIG. 2) but selects a category 22, he will not be asked to choose between instances (FIG. 3), but will proceed directly to a screen of the type of FIG. 4.

The query expansion method can operate as follows:

An object is to produce a information retrieval query string that will return to the user a set of highly relevant documents when sent to a search engine.

1. A visual map of terms/words is displayed to the user. The map is configured by arranging the terms with respect to a predefined set of term relations (for example lexically based, classification based).

2. The user is given a dialogue box in which to type a term which will be used as the initial term in the query string. As the user continues to browse the terms is able to include more terms in the query string simply by using a selection device, such as a mouse, to click once on the term. When a term is chosen by clicking, the map of terms is redrawn to reflect the new configuration with respect to the newly chosen word.

3. As the user selects new words/terms to add to the query string, the query string is automatically sent to a search engine which returns the retrieved documents to the user in a separate window or part of the same window. The user can look at the document and alter the query string by navigating through the map of terms to achieve more precise results.

Thus embodiments of the invention provide a Web-based application for assisting users with the arduous task of searching the Web. it displays hierarchically related words for a given query term in the form of a navigable map. An aim is to help users with Web searching by suggesting or prompting them with terms to expand the search query.

An example of a search is as follows:

1. The user clicks on the term “auctions” which is a subcategory of “shopping”

The query string “auctions shopping” is forwarded to the search engine. If facts about the user are known, such as his location, further search terms may be added.

2. Web results and directory listings are returned as described above. The user clicks on one of the terms: “autos”.

The query string “autos motor vehicles cars bids auctions” is forwarded to the search engine, “motor vehicles” and “cars” being broadly synonymous terms and “bid” being a term statistically determined or judged by editors to be relevant.

3. Web results and directory listings are returned as described above.

The user now adds the terms “mercedes” and “uk” to the search box 34, thus further refining the search.

4. The terms added by the user are stored; these may be added to subsequent search strings for other users.

It will be understood that the present invention has been described above purely by way of example, and modifications of detail can be made within the scope of the invention.

Each feature disclosed in the description, and (where appropriate) the claims and drawings may be provided independently or in any appropriate combination.

In any or all of the aforementioned, certain features of the present invention have been implemented using computer software. However, it will of course be clear to the skilled man that any of these features may be implemented using hardware or a combination of hardware and software. Furthermore, it will be readily understood that the functions performed by the hardware, the computer software, and such like are performed on or using electrical and like signals.

Features which relate to the storage of information may be implemented by suitable memory locations or stores. Features which relate to the processing of information may be implemented by a suitable processor or control means, either in software or in hardware or in a combination of the two.

In any or all of the aforementioned, the invention may be embodied in any, some or all of the following forms: it may be embodied in a method of operating a computer system; it may be embodied in the computer system itself; it may be embodied in a computer system when programmed with or adapted or arranged to execute the method of operating that system; and/or it may be embodied in a computer-readable storage medium having a program recorded thereon which is adapted to operate according to the method of operating the system.

As used herein throughout the term “computer system” may be interchanged for “computer”, “system”, “equipment”, “apparatus”, “machine” and like terms.

1. An apparatus for use in searching, the apparatus including:
means for selecting a keyword;
means for determining a first wordset, the first wordset having a first lexical relationship with the keyword; and
means for determining a second wordset, the second wordset having a second lexical relationship with the keyword.

2. An apparatus according to claim 1, wherein the first wordset includes a hyponym of the keyword and preferably the first wordset includes at least five hyponyms of the keyword.

3. An apparatus according to claim 1 or claim 2, wherein the second wordset includes a hyperonym of the keyword.

4. An apparatus according to claim 3, wherein the apparatus further includes means for determining a third wordset having a third lexical relationship with the keyword, and preferably the third wordset includes a hyponym of the second wordset, and preferably includes at least five hyponyms of the second wordset.

5. An apparatus according to claim 3 or claim 4, wherein the apparatus further includes a fourth wordset having a fourth lexical relationship with the 25 keyword, and preferably the fourth wordset includes a further hyperonym of the keyword.

6. An apparatus according to any one of claims 3 to 5, wherein the apparatus further includes means for determining a fifth wordset, the fifth wordset including a hyperonym of the second wordset.

7. An apparatus according to claim 6, wherein the apparatus further includes means for determining a hyperonym of the fifth wordset.

8. An apparatus according to any one of claims 1 to 7, wherein the apparatus further includes a display, wherein the display is adapted to display terms of the wordsets and preferably also the keyword.

9. An apparatus according to claim 8, wherein the apparatus includes means for replacing the keyword with a displayed term.

10. An apparatus according to claim 8 or claim 9, wherein the apparatus includes a cache for storing terms and selection means for selecting terms from the wordsets and entering the terms in the cache, and preferably storing the terms in the cache in the form of a search string.

11. An apparatus according to claim 10, the apparatus including search means for carrying out a search of the database using the terms in the cache.

12. An apparatus according to any one of claims 1 to 11, wherein the apparatus includes a plurality of wordsets, each wordset including a plurality of terms and each wordset having a lexical relationship with at least one other wordset.

13. An apparatus according to any one of claims 1 to 12, wherein the apparatus further includes a plurality of terms and the apparatus includes lexical information associated with each term, the information preferably identifies a hyperonym of the term.

14. An apparatus according to claim 12 or claim 13, wherein the apparatus includes lexical information associated with each wordset the information preferably including at least one of a hyperonym wordset and a hyponym wordset of the wordset.

15. An apparatus according to any one of claims 1 to 14, wherein the apparatus is adapted for searching a computer based network.

16. An apparatus for forming a search string for use in a search, the apparatus comprising:
means for entering a keyword;
means for determining a plurality of terms, the terms having a lexical relationship with the keyword; and
means for forming a search string including one or more of the terms.

17. A method of forming a search string, the forming of the search string comprising the steps of:
entering a keyword;
determining a wordset, the wordset including terms having a lexical relationship with the keyword; and
selecting a term from the wordset to form a search string including the selected term.

18. A method according to claim 17, the method further including the step of displaying the wordsets.

19. A method according to claim 17 or claim 18, further including the step of replacing the keyword with a term of a wordset.

20 A method of searching, the method including forming a search string according to any one of claims 17 to 19 and carrying out the search using the search string.

21. A method of searching using an apparatus according to any one of claims 1 to 16.

22. A computer system comprising:
an input for entering a keyword;
a processor for determining terms having a lexical relationship with the keyword; and
a display for displaying a keyword and terms.

23. A computer system according to claim 22, further comprising a database of terms, each term of the database including information of the lexical relationship of the term with another term of the database.

24. A computer system comprising apparatus according to any one of claims 1 to 16.

25. A computer program for carrying out a method according to any one of claims 17 to 21.

26. A computer readable storage medium having a program recorded thereon adapted to carry out a method according to any one of claims 17 to 21.

27. A database of terms, each term of the database including information of the lexical relationship of the term with another term of the database.

28. A database according to claim 27, wherein the database includes a plurality of wordsets, each wordset including a plurality of terms and each wordset having a lexical relationship with at least one other wordset.

29. Use of a database according to claim 27 or claim 28 for forming a search string.

30. An apparatus for use in searching, the apparatus being substantially as herein described having reference to FIG. 1.

31. A method of searching, the method being substantially as herein described having reference to FIG. 1.

32. A method of carrying out a search including: generating a plurality of terms for selection; determining that a term has been selected; and initiating a search on the basis of the term selected.

33. A method according to claim 32, further comprising displaying the search results.

34. A method according to claim 32 or 33, wherein the method is such that the selection of the term initiates the search.

35. A method according to any one of claims 32 to 34, wherein the term is selected using a single user action.

36. A method according to any one of claims 32 to 35, further including the step of carrying out the search using a predetermined search string associated with the selected term.

37. A method according to any one of claims 32 to 36, further including generating a search string on the basis of the term selected.

38. Method of generating a search string including: generating a plurality of terms for selection; determining that a term has been selected; and generating a search string on the basis of the term selected.

39. A method according to claim 37 or claim 38, comprising adding the selected term to a search string.

40. A method according to any one of claims 37 to 39, further including the step of adding further terms to the search string on the basis of the term selected.

41. A method according to any one of claims 37 to 40, further including the step of generating a further plurality of terms on the basis of the term selected.

42. A method according to any one of claims 41, including generating a plurality of groups of terms, one group having a relationship to another group.

43. A method according to any one of claims 37 to 42, including generating terms related to the selected term, and preferably generating groups of terms related to the selected term.

44. A method according to any one of claims 37 to 43, further including the step of determining that a further term has been selected and initiating a search on the basis of the further term selected.

45. A method according to any one of claims 37 to 44, further including the step of determining that a further term has been selected and generating a search string on the basis of the further term selected.

46. A method according to any one of claims 37 to 45, further including storing information relating to the selected term.

47. A method according to claim 46, further including using the stored information in the generation of the search string.

48. A method according to any one of claims 37 to 47, the method including the step of automatically including terms in the search string.

49. Method of generating a search string, the method comprising adding terms to a search string on the basis of a selected search term.

50. A method according to any one of claims 32 to 49, comprising tracking a user's path through an interface, and generating a search string on the basis of the path.

51. Method of generating a search string including tracking a user's path through an interface and generating a search string on the basis of the path.

52. A method of carrying out a search including: generating a first set of terms; determining that a first term has been selected of the first set of terms; initiating a first search on the basis of the first term; generating a second set of terms on the basis of the first term; determining that a second term has been selected of the second set of terms; and initiating a second search on the basis of the first term and the second term.

53. A method of searching, the method comprising: viewing a set of terms; and selecting a term from the set of terms; wherein the selection of the term initiates the search.

54. A method according to claim 53, further comprising, viewing a further set of terms and selecting a further term from the further set of terms, wherein the selection of the further term initiates a further search.

55. A method according to claim 54, wherein the further search is carried out on the basis of the term and the further term.

56. A computer based method according to any one of claims 32 to 55.

57. Apparatus for carrying out a method according to any one of claims 32 to 56.

58. An apparatus for use in searching the apparatus including: means for generating a plurality of terms; means for selecting a term; and means for initiating a search on the basis of the term selected.

59. An apparatus according to claim 57 or claim 58, further comprising means for displaying the search results.

60. An apparatus according to any one of claims claim 57 to 59, wherein the apparatus is such that the selection of the term initiates the search.

61. An apparatus according to any one of claims 57 to 60, further including means for retrieving a predetermined search string associated with the selected term.

62. An apparatus according to any one of claims 57 to 61, further including means for generating a search string on the basis of the term selected.

63. An apparatus for use in searching, the apparatus including: means for generating a plurality of terms; means for selecting a term; and means for generating a search string on the basis of the term selected.

64. An apparatus according to any one of claims 57 to 63, further including a memory for storing information relating to the selected term.

65. An apparatus for generating a search string, the apparatus including means for adding terms to a search string on the basis of a search term.

66. An apparatus for generating a search string, the apparatus comprising means for: tracking a user's path through an interface; and generating a search string on the basis of the path.

67. An apparatus according to any one of claims 57 to 66, adapted for use in searching a computer based network.

68. An apparatus according to any one of claims 57 to 67, the apparatus comprising a computer system.

69. A method of searching using an apparatus according to any one of claims 57 to 68.

70. A database of terms for use in a method according to any one of claims 1 to 56 or in an apparatus according to any one of claims 57 to 69.

71. A database comprising a plurality of terms, and further comprising a search string, wherein the search string is associated with a term.

72. A database according to claim 70 or claim 71, comprising a plurality of search strings, each search string being associated with a term of the database.

73. A database according to any one of claims 70 to 72 wherein the terms comprise an ontological structure.

74. Use of a database according to any one of claims 70 to 73 in searching.

75. A computer adapted to carry out a method according to any one of claims 1 to 56.

76. A computer program for cairying out a method according to any of claims 1 to 56.

77. A computer-readable storage medium having a program recorded thereon which is adapted to operate according to a method according to any one of claims 1 to 56.

78. A computer-readable storage medium according to claim 77, further including a database according to any one of claims 70 to 73.

79. An apparatus for use in searching, the apparatus being substantially as herein described having reference to FIGS. 2 to 4.

80. A method of searching, the method being substantially as herein described having reference to FIGS. 2 to 4.
